(19) United States
(12) Patent Application Publication
(10) Pub. No.: US 2024/0270588 A1
(43) Pub. Date: Aug. 15, 2024

(54) PROCESS FOR TREATMENT OF A SODIUM SULFATE CONTAINING RESIDUE PROCESS STREAM OF A BATTERY MANUFACTURING FACILITY, A BATTERY RECYCLING FACILITY, OR A STEEL PRODUCTION PLANT

(71) Applicant: Cinis Fertilizer AB, Lund (SE)

(72) Inventor: Jakob Liedberg, Lund (SE)

(73) Assignee: Cinis Fertilizer AB, Lund (SE)

(21) Appl. No.: 18/562,809

(22) PCT Filed: May 24, 2022
(86) PCT No.: PCT/SE2022/050503

§ 371 Date: Nov. 20, 2023

(30) Foreign Application Priority Data
May 25, 2021 (SE) 2150661-3
Nov. 25, 2021 (SE) 2151435-1
Dec. 13, 2021 (SE) 2151520-0

(51) Int. Cl. C01D 5/06; C01G 31/02; C05D 1/02; C21B 3/04; C22B 7/04; C22B 34/22; H01M 10/54

(52) U.S. Cl. CPC C01D 5/06; C01G 31/02; C05D 1/02; C21B 3/04; C22B 7/04; C22B 34/22; H01M 10/54

(57) ABSTRACT

The present invention relates to a method for producing a potassium sulfate containing fertilizer composition from a sodium sulfate containing residue process stream of a battery manufacturing facility, battery recycling facility, or steel production plant, wherein residue process stream from a battery manufacturing facility, battery recycling facility, or steel production plant is provided; optionally water is provided; potassium chloride is provided; and a reaction mixture is provided comprising said optional water, potassium chloride and residue process stream, and is allowed to react, wherein potassium sulfate is obtained.

### FIELD OF THE INVENTION

The present invention relates to a process for providing value adding products from a residue process stream from a battery production or recycling facility, or a steel production plant.

### BACKGROUND

Today there is an increasing focus on providing more sustainable products and processes. Different industries are aiming to make better use of the Earth's finite resources.

An increased awareness of climate change and the limited supply of fossil fuels are of great interest today.

Said awareness and limited supply have boosted the search alternative energy sources for e.g. operation of vehicles. The demand for batteries based on lithium-ion technology is growing fast. This means also that the emissions, solid and liquid residues from battery production increases. Recycling, and material optimization has thus become a relevant issue in recent years. Resource optimization has become something that most countries consider necessary for continued application of lithium-ion batteries today and for the future.

Many industries want to improve the sustainability of their products and processes, and e.g. limit the amount of waste materials produced from a facility.

The battery manufacturing industry is working continuously to minimize residue provision, and aim to recycle of process essential chemicals like cobalt, lithium and manganese which aid to reduce the facility's operating costs. Residues from a battery manufacturing process may be aqueous wastewater streams, ammonia, n-methyl pyrrolidone, and hazardous waste such as battery metal components. However, as residue streams, especially wastewater streams, may be quite voluminous, reducing the amount of residues and provide value adding components from the streams classified as waste is desirable to improve the overall operation in terms of costs and raw material usage of the battery manufacturing facility, and allowing reuse of the Earth's finite resources. Also, local or national regulations may influence if battery production is allowable in view of residues and emissions provided from the processes especially with regards to emissions to a water recipient. Non-desirable elements like sulfates, and sodium, may be provided in high levels in different production processes, such as steel production in steel mills, or battery production or recycling, and said non-desirable elements negatively influence the residue process streams as they are expensive to dispose of, and if forwarded directly to sewers and/or wastewater treatment plants they put a lot of stress on said downstream processes. The presence, or prospect of presence, of high amounts of sulfates and sodium would today prevent approval of permits for establishing a battery production facility, or a battery recycling facility. Sodium sulfate is a problematic by-product to be handled for battery manufacturers, battery recycling companies, or steel producers. In view of the volumes produced, the costs for handling sodium sulfate may be substantial, also a lack of addressing chemical handling may prevent a company from receiving needed permits to continue their production or obtain new permits for increase in production or building new production facilities.

Also, the battery recycling industry is working continuously to minimize residue provision. The same is also true for the steel production industry.

Today sodium sulfate present in residue process streams may be rejected e.g. to the wastewater system via drains or sewers, or onto landfills or separated from the residue stream and sold as low-grade chemicals. Residue process streams from a battery production facility containing sodium sulfate mainly originates from the oxidation step of the cathode production. Residue process streams from a steel mill containing sodium sulfate mainly originates from vanadium recovery. Even if sodium sulfate is considered a waste material, if a use therefore could be provided it could become a valued asset as the sodium sulfate can be present in large amounts. For a battery manufacturing facility, a battery recycling facility, or a steel mill handling the obtained sodium sulfate is considered a problem. However, if sodium sulfate could be put to good use it could become a valuable-adding product for the overall process.

A problem with the present residue process streams of battery manufacturing facilities is that possible valuable chemicals are not retrieved or recycled therefrom. In reality, a large amount of chemicals is always discharged to landfill, or disposed of as low-grade chemicals, or sent to wastewater system. The same is also true in the case of battery recycling facilities, such as in the case of e.g. processing lithium batteries for recycling purposes, e.g. electrical vehicle (EV) batteries. This is another focus of the present invention. Also, for steel production plants, possible valuable chemicals of residue process streams may not be retrieved or recycled therefrom. Also here, in reality, a large amount of chemicals may be discharged to landfill, or disposed of as low-grade chemicals, or sent to wastewater system.

Today also much focus is put on obtaining environmentally sustainable processes and obtaining as much value adding products or recyclable products out of a process as possible, in order to avoid as much waste and losses as possible.

Thus, there is a need to obtain more efficient processes. There is a demand for processes which reduces the need for putting material on landfills and discharging valuable chemicals to wastewater system. There is also a need for providing additional value adding products from waste material from battery manufacturing facilities, battery recycling facilities, or steel mills, which improves the economy of the total battery manufacturing facilities, total battery recycling facilities, or total steel mills, respectively.

### SUMMARY

With the present process, high value products are obtainable and at the same time an environmentally more sustainable solution to waste handling is provided. By providing an added-value product that have a demand on the market and may be sold the total economy of a battery production facility, battery recycling facility, or steel mill, is improved and the recourses of Mother Nature are used with caution. Also, the process enables possibility to meet requirements and legislations related to waste handling for battery manufacturing, or recycling.

Residue process streams from battery manufacturing used in the present process may come from the oxidation step of the cathode production in (lithium-ion) battery manufacturing, in which step sodium sulfate is formed. The residue process streams may be wastewaters from the oxidation step of the cathode production. Residue process streams from battery manufacturing, which today is forwarded to landfill or the wastewater system, or concentrated to produce a solid residue, may according to the present invention be treated with potassium chloride in order to create a high value fertilizer, K₂SO₄, and a byproduct, NaCl, which may be used in different applications e.g. road salt. Residue process streams containing sodium sulfate, which originate from the oxidation step of the cathode production of lithium-ion batteries, may be in the form of aqueous wastewaters. Such waste waters may be concentrated by evaporation of at least a portion of the water content before proceeding to the present process. Such waste waters may be dried to provide a dry residue process stream.

The residue process stream from battery recycling may come from processing lithium containing batteries. The residue process stream may be obtained from a black mass material which comprises lithium iron phosphate.

The residue process stream from steel production may come from slag processing involving vanadium recovery.

With the invention a huge amount of chemical, namely sodium sulfate, present in the residue process stream (as stated herein from battery manufacturing, battery recycling or steel production) can be used and the negative environmental impact from a battery manufacturing residue process stream, a battery recycling residue process stream, or a steel production plant residue process stream can be eliminated. Since a high-grade fertilizer is obtained by the present invention is it also possible to forward the nutrient chemicals to plants, where they are needed, instead of forwarding them out to a drain or sewer, or onto landfills or separated as low-grade chemicals.

The invention may be applied and implemented to any battery manufacturing facility, battery recycling facility, or steel mill, that provide a residue process stream or treat a residue process stream in a residue process treatment system, which residue process streams comprises sodium sulfate, such as an aqueous residue process stream or treat aqueous residue process streams in a residue process treatment system, which residue process streams comprises sodium sulfate.

The scope of the present invention is in accordance with the appended claims.

The present invention relates to a method for producing a potassium sulfate, K₂SO₄, containing fertilizer composition from a residue process stream of a battery manufacturing facility, battery recycling facility, or steel production plant, wherein a residue process stream from a battery manufacturing facility, battery recycling facility, or steel production plant is provided; optionally water is provided, if the residue process stream does not contain water or do not contain water in a sufficient amount;
potassium chloride is provided; and a mixture is provided comprising said optional water, potassium chloride and residue process stream, and is allowed to react, wherein potassium sulfate is obtained.

According to one embodiment the potassium chloride and the residue process stream are provided in any order or simultaneously to provide said mixture. The potassium chloride, optional water, and residue process stream may be provided in any order, or simultaneously, and mixed to provide said mixture. The residue process stream, the potassium chloride, and optional water, may be provided in any order, or simultaneously, and said components may be contacted in any order or simultaneously, and mixed to provide said mixture. The mixture of potassium chloride, residue process stream, and optional water may be provided by simultaneous addition or sequential addition in any order, and mixing, to provide said mixture. The mixture may be obtained by first mixing the provided residue process stream, and optional water, and thereafter admixing potassium chloride. Alternatively, the mixture may be obtained by first mixing the provided residue process stream, and potassium chloride, and thereafter admixing of optional water. Alternatively, the mixture may be obtained by first mixing the provided optional water, and potassium chloride, and thereafter admixing the residue process stream. Alternatively, the mixture may be obtained by first mixing the provided residue process stream, and optional water, and thereafter admixing of the potassium chloride, optionally mixed with additional optional water. Preferably the optional water and residue process stream are added before the potassium chloride. Both the residue process stream and the potassium chloride may be combined with optional water before being combined and mixed with each other, i.e. the residue process stream, the potassium chloride, and optional water, to form said mixture. In a preferred embodiment the residue process stream is combined and mixed with any optional water before being contacted and mixed with the potassium chloride to form said mixture.

According to one embodiment acid is admixed to the mixture. Preferably sulfuric acid and/or hydrochloric acid is used, more preferably sulfuric acid. Preferably the acid is added before the addition of the potassium chloride. Such addition may be made to adjust the pH of the mixture.

According to one embodiment the residue process stream is contacted with the potassium chloride.

The residue process stream including sodium sulfate, originating from battery manufacturing, battery recycling, or a steel production plant, may contain water, be mixed with water, or at least partially dissolved in water. The residue process stream may be a solution. The residue process stream may be pretreated in an evaporation step in order to produce a dry residue process stream. Such pretreated dry residue process stream may then be contacted with water and thereafter is contacted with the potassium chloride. Alternatively, such pretreated dry residue process stream may then be contacted with the potassium chloride, and thereafter is contacted with water. Alternatively, such pretreated dry residue process stream may then be contacted with the potassium chloride, which potassium chloride has already been contacted with water.

According to one embodiment sodium hydroxide and/or potassium hydroxide is added to the water, potassium chloride, and residue process stream mixture. This is done to adjust the pH, e.g. if acid has been added.

According to one embodiment glaserite is obtained by the reaction of the water, the potassium chloride and the residue process stream, said glaserite is removed and admixed with additional potassium chloride and/or is leached with water to provide potassium sulfate. The potassium sulfate may then be removed for further use or sold. It is to be noted that the admixing of potassium chloride and leaching with water may be done in any order. However, in a preferred embodiment the reaction with potassium chloride is performed first, followed by leaching with water.

According to one embodiment the remaining mixture after removal of potassium sulfate is concentrated, where after any sodium chloride present is removed, e.g. for further use.

According to one embodiment the removed sodium chloride is forwarded to a cell membrane process converting it to sodium hydroxide, hydrogen and chlorine.

According to one embodiment the removed sodium chloride is forwarded to a cell membrane process converting it to sodium hydroxide, hydrogen and chlorine.

According to one embodiment the residue process stream from a battery manufacturing facility originates from a lithium battery manufacturing facility, such as from a battery manufacturing facility producing batteries selected from lithium cobalt oxide, lithium manganese oxide, lithium nickel manganese cobalt oxide, lithium iron phosphate, lithium nickel cobalt aluminum oxide, lithium titanate, or any combination thereof, preferably from a battery manufacturing facility producing lithium nickel manganese cobalt oxide batteries.

According to one embodiment the residue process stream from a battery recycling facility originates from a battery recycling facility for lithium containing batteries. The lithium containing batteries being recycled may be selected from batteries comprising lithium cobalt oxide, lithium manganese oxide, lithium nickel manganese cobalt oxide, lithium iron phosphate, lithium nickel cobalt aluminum oxide, lithium titanate, or any combination thereof, preferably from batteries comprising lithium nickel manganese cobalt oxide.

According to one embodiment the sodium sulfate containing residue process stream from a steel production plant originates from the processing of a slag for vanadium recovery. The vanadium recovery may comprise vanadium purification by addition of sodium hydroxide which in turn provides vanadium pentoxide as one product stream and the sodium sulfate containing residue process stream as another product stream. The sulfate containing residue process stream from a steel production plant may be obtained by addition of sulfuric acid and/or aluminum sulfate after the vanadium purification.

According to one embodiment the potassium chloride added to the residue process stream has been subjected to a pretreatment step including washing with water and optionally subsequent evaporation to remove any impurities present in the potassium chloride.

The present invention also relates to use of the present process for the production of a fertilizer comprising potassium sulfate.

### SHORT DESCRIPTION OF THE DRAWINGS

FIG. 1 discloses a schematic embodiment of the present process.

FIG. 2 discloses a schematic overview of a cathode oxidation step in battery production and where sodium sulfate is forwarded to the present process.

### DETAILED DESCRIPTION

The present invention relates to providing valuable components from residue process streams of battery manufacturing, battery recycling, or a steel production plant. With the present invention a high value fertilizer, K₂SO₄, is obtained, and, in addition, a byproduct, NaCl, may also be obtained, which may be used in different applications e.g. road salt.

In particular, it is related to residue process streams from lithium-ion battery manufacturing or battery recycling, e.g. batteries selected from lithium cobalt oxide (LiCoO₂ or LCO), lithium manganese oxide (LiMn₂O₄ or LMO), lithium nickel manganese cobalt oxide (LiNiMnCoO₂ or NMC), lithium iron phosphate (LiFePO₄ or LFP), lithium nickel cobalt aluminum oxide (LiNiCoAlO₂ or NCA), lithium titanate (Li₂TiO₃ or LTO). In particular, the present invention relates to providing valuable components from residue process streams of lithium nickel manganese cobalt oxide (LiNiMnCoO₂ or NMC) battery manufacturing or battery recycling.

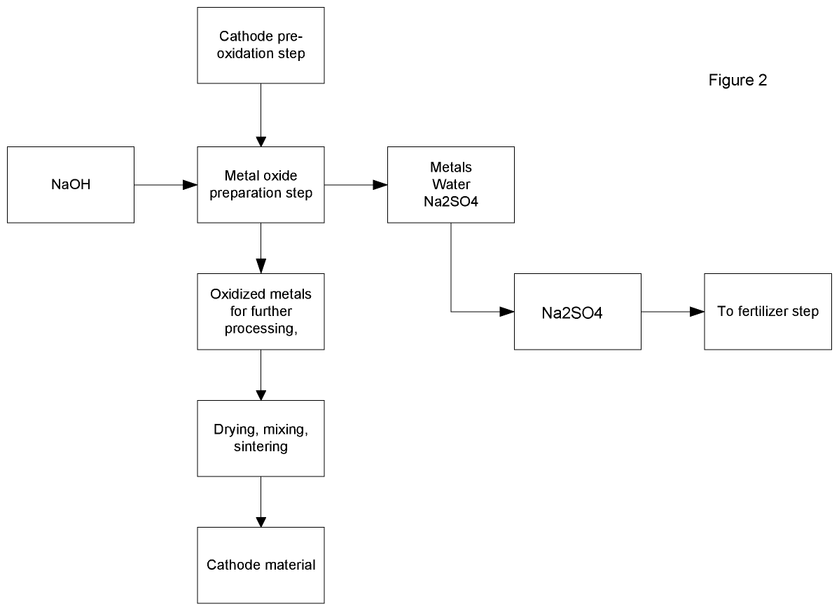

As stated above, residue process streams from battery manufacturing used in the present process may come from the oxidation step of the cathode production in (lithium-ion) battery manufacturing, in which step sodium sulfate is formed. The residue process streams may be wastewaters from the oxidation step of the cathode production. Residue process stream, used in the present process, is preferably obtained in the battery manufacturing process from the cathode production step, more specifically the residue process stream is provided from the oxidation step of the cathode production. In the cathode production step sodium hydroxide and sulfuric acid are used. Said residue process stream from battery manufacturing facilities contains mostly sodium, sulfate, as well as trace amounts of several metals and elements, nickel, cobalt, ammonia and lithium. FIG. 2 discloses a schematic view of the cathode production step.

As should be understood from above, lithium containing batteries is one focus area according to the present invention. Furthermore, according to another embodiment, the residue process stream from the battery recycling facility is obtained from a black mass material which comprises lithium iron phosphate. Moreover, according to yet another embodiment, the concentration of lithium is increased in relation to the total of lithium, iron and phosphate, preferably by separating off iron and/or phosphate, before being provided as the residue process stream from the battery recycling facility.

Residue process streams from a steel production plant, used in the present process, may be a sodium sulfate containing residue process stream from the slag processing involving vanadium recovery. In this regard it may also be mentioned that according to one embodiment, the sodium sulfate containing residue process stream originates from the processing of a slag for vanadium recovery. Moreover, according to yet another embodiment, the vanadium recovery comprises vanadium purification by addition of sodium hydroxide which in turn provides vanadium pentoxide as one product stream and the sodium sulfate containing residue process stream as another product stream. Furthermore, according to one specific embodiment, the sulfate containing residue process stream is obtained by addition of sulfuric acid and/or aluminum sulfate after the vanadium purification.

In the present process the residue process stream, optional water, and potassium chloride may be provided and mixed in any order, or simultaneously to provide a mixture, i.e. the residue process stream, optional water, and potassium chloride may be contacted in any order, or simultaneously and mixed to provide the mixture. The mixture may be provided by:
the potassium chloride, optional water, and residue process stream are provided simultaneously, and mixed,
the residue process stream and optional water are provided, and mixed, followed by admixing the potassium chloride,
the residue process stream and potassium chloride are provided, and mixed, followed by admixing optional water,
the residue process stream and optional water are provided, and mixed, and the potassium chloride and optional water are provided, and mixed, followed by mixing the potassium chloride and optional water with the residue process stream and optional water, or
the potassium chloride and optional water are provided, and mixed, followed by admixing the residue process stream.

A residue process stream including sodium sulfate, originating from battery manufacturing, battery recycling, or a steel production plant, may be mixed with and at least partially dissolved in water. Preferably the residue process stream is a solution. Components of the residue process stream is preferably dissolved. The aqueous mixture of the residue process stream may optionally be treated with an acid, preferably sulfuric acid. The optional use of acid may depend on the composition of the residue process stream.

The residue process stream may vary in chemical content and can contain the following impurities:
Na₂SO₄, nickel, cobalt, ammonia, lithium, and NaOH—if the residue process stream provided from a battery manufacturing facility,
Na₂SO₄, calcium, lithium, aluminium, iron, and manganese—if the residue process stream provided from a battery recycling facility, or
Na₂SO₄, silicon, iron, potassium, and calcium—if the residue process stream provided from a steel production plant.
   Optionally a subsequent step of pH modification using an alkaline compound may be used, e.g. if the above-mentioned acid has been added in the process. Preferably KOH and/or NaOH are used as alkaline compounds. The addition of alkaline compound may be used to increase the pH and achieve a correct stoichiometric relation with regards to K₂SO₄ and NaCl.

Potassium chloride, KCl, is added to the aqueous mixture comprising the residue process stream in order to obtain potassium sulfate. The solid phase obtained in the process may comprise a salt called glaserite composed of potassium and sodium sulfate (K₃Na(SO₄)₂). In one embodiment the intermediate product obtained in the present process after the first addition of the potassium chloride is glaserite.

The obtained glaserite salt is removed from the treated residue process stream, the liquid remaining part of the mixture, and may be further treated with KCl in order to produce K₂SO₄. The obtained K₂SO₄ may thereafter be removed.

The reactions are for the production of the intermediate glaserite and the K₂SO₄ are disclosed below.

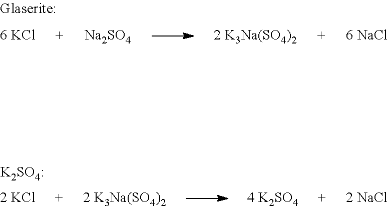

As an alternative processing, the obtained glaserite salt may after removal from the treated residue process stream be leached in water in order to provide K₂SO₄.

However, in a further embodiment, the present process may include a combination of both mentioned treatment steps for the glaserite, in any order. Then the obtained glaserite salt may first be treated with KCl and thereafter leached in water in order to produce K₂SO₄, or the other way around.

The potassium chloride used in the present process may be subjected to a pretreatment step including washing and optionally evaporation prior to addition to the residue process stream. Pretreatment by washing with water allows for removal of byproducts or impurities present. Potassium chloride products provided on the market often contains some byproducts or impurities, such as e.g. sodium chloride. By subjecting the potassium chloride to a water wash, any impurities present may be removed from the potassium chloride and thus improving the quality of the potassium chloride to be added to the residue process stream. By performing a pretreatment using a water wash, and optionally a subsequent evaporation of water, the quality of the potassium chloride may e.g. be improved from containing about 4 wt % sodium chloride to contain at most 1 wt % sodium chloride. Such an increase in purity of the potassium chloride used in the present process improves the yield of potassium sulfate obtained in the conversion step at least five times, when the conversion to potassium sulfate is performed at a pH of about 5-9, such as about 6 to 8, and preferably about 6-7.

The treated residue process stream remaining after the separation of K₂SO₄ may be further processed, e.g. via a cooling step in order to precipitate sodium sulfate and improve the yield of sulfates by returning said sulfates to the process.

The treated residue process stream remaining after the separation of K₂SO₄ may be further processed, e.g. via evaporation in order to precipitate sodium chloride (NaCl) which may be removed as a solid phase. This may then be used as e.g. road salt.

The present invention can further be complemented by the use of a membrane cell process which may convert the obtained NaCl into NaOH, H₂ and Cl₂. NaOH is a valuable chemical and used by the battery manufacturing plant, battery recycling plant, or steel production plant, e.g. in vanadium purification of the steel production plant. The two other products H₂ and Cl₂ may be collected and either used by as energy in the case of H2 or sold to third party to improve the economy and profitability of the battery process, or total process.

In this manner more value adding products than the fertilizer produced may be obtained and reused in the battery manufacturing process, battery recycling process, or total steel production process, or other processes or sold.

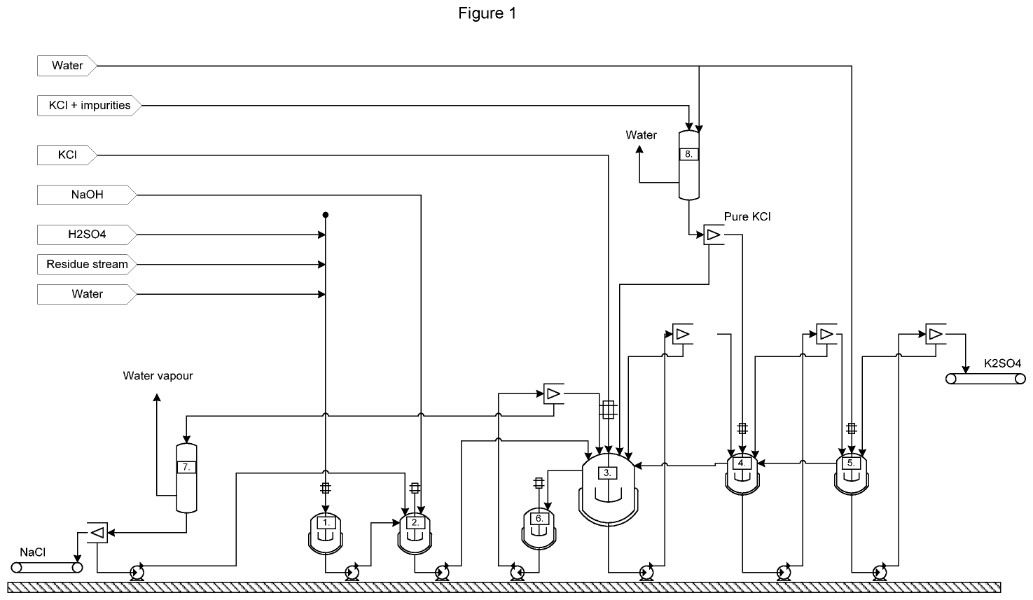

With reference to FIG. 1 it is shown that in step 1 residue process stream and water are admixed. Water addition may be optional, if the residue process stream already contains sufficient amounts of water. Alternatively, only a minor water addition may be made, if the residue process stream already contains some amount of water. In one embodiment the residue process stream and water may be replaced by or combined with the reject from a pretreatment residue process stream processing system. Optionally acid may be added also in step 1, e.g. sulfuric acid.

The residue process stream comprising mixture may optionally be mixed with KOH and/or NaOH in step 2, where the pH of the mixture is raised and the solution may reach the correct stoichiometric relation with regards to K₂SO₄ and NaCl to be obtained. The alkaline compounds may not be needed in step 2, e.g. if no acid has been added in step 1.

Thereafter in step 3, the residue process stream mixture is mixed with KCl in order to obtain K₂SO₄. The process may create a mixed salt of potassium and sodium sulfate, which is called glaserite. This glaserite salt may then be removed and forwarded to the next step 4 where it is allowed to react in a water solution with additional KCl and may then be further leached in water in step 5 in order to create the end product K₂SO₄. It is to be noted that any one of steps 4 and 5 may be used alone, or in combination. The K₂SO₄ in solid phase is separated from the treated residue process stream, which may be recycled.

The remaining liquid of the steps 3, 4 and 5 may be recycled to the previous step of the process in counter current flow with the precipitated salts. In step 3 where glaserite may be formed, the treated residue process stream from the step is forwarded to a cooling step 6 in order to precipitate more sulfate salts which are separated and recirculated back to step 3.

The remaining solution after the cooling step 6, which has a low amount of sodium sulfate and potassium but also comprises sodium and chlorides, is sent to an evaporation step 7 where water is removed in order to increase the salt concentration and to precipitate NaCl as a solid phase and separate salt from the solution. The water driven off in the evaporation step where NaCl is precipitated and removed from the solution, can be recycled to the process to close the system and be used to dilute reject or dissolve new residue process stream.

To further enhance the reaction of glaserite into potassium sulfate in step 4 the KCl is washed and cleaned from impurities in order to generate a KCl with high purity which enhanced the yield in step 4 up to 5 times.

Almost all reactions occur at room temperature or slightly above and therefore the process according to the present invention is not very energy demanding, except for the evaporation of water in the NaCl precipitation step 7.

A membrane cell process can additionally be added to the present process in order to provide NaOH for the battery production facility, battery recycling facility, or steel production plant, such as in the vanadium purification, from the generated byproduct, NaCl.

1. A method for producing a potassium sulfate containing fertilizer composition from a sodium sulfate containing residue process stream of a battery manufacturing facility, battery recycling facility, or steel production plant, wherein the residue process stream from a battery manufacturing facility, battery recycling facility, or steel production plant is provided;
optionally water is provided;
potassium chloride is provided; and
a mixture is provided comprising said optional water, potassium chloride and residue process stream, and is allowed to react, wherein potassium sulfate is obtained.

2. The process according to claim 1, wherein the potassium chloride, the residue process stream, and optional water are provided and mixed in any order, or simultaneously to provide said mixture, preferably said mixture is provided by:
the potassium chloride, optional water, and residue process stream are provided simultaneously, and mixed,
the residue process stream and optional water are provided, and mixed, followed by admixing the potassium chloride,
the residue process stream and potassium chloride are provided, and mixed, followed by admixing optional water,
the residue process stream and optional water are provided, and mixed, and the potassium chloride and optional water are provided, and mixed, followed by mixing the potassium chloride and optional water with the residue process stream and optional water, or
the potassium chloride and optional water are provided, and mixed, followed by admixing the residue process stream.

3. The process according to claim 1, wherein the residue process stream and optional water are added before the potassium chloride.

4. The process according to claim 1, wherein acid is admixed to the mixture, preferably before the addition of the potassium chloride.

5. The process according to claim 1, wherein the residue process stream has been pretreated in an evaporation step in order to produce a dry matter that is contacted with the water and thereafter is contacted with the potassium chloride.

6. The process according to claim 1, wherein sodium hydroxide and/or potassium hydroxide is added to the water, potassium chloride, and residue process stream mixture.

7. The process according to claim 1, wherein glaserite is obtained by the reaction of the water, the potassium chloride and the residue process stream, said glaserite is removed and admixed with additional potassium chloride and/or is leached with water to provide potassium sulfate.

8. The process according to claim 7, wherein the remaining mixture after removal of potassium sulfate is concentrated, whereafter any sodium chloride present is removed.

9. The process according to claim 8, wherein the removed sodium chloride is forwarded to a cell membrane process converting it to sodium hydroxide, hydrogen and chlorine.

10. The process according to claim 1, wherein the residue process stream from a battery manufacturing facility originates from a lithium battery manufacturing facility, preferably from a battery manufacturing facility producing batteries selected from lithium cobalt oxide, lithium manganese oxide, lithium nickel manganese cobalt oxide, lithium iron phosphate, lithium nickel cobalt aluminum oxide, lithium titanate, or any combination thereof, preferably from a battery manufacturing facility producing lithium nickel manganese cobalt oxide batteries.

11. The process according to claim 1, wherein the residue process stream from a battery recycling facility originates from a battery recycling facility for lithium containing batteries.

12. The process according to claim 11, wherein said lithium containing batteries being recycled may be selected from batteries comprising lithium cobalt oxide, lithium manganese oxide, lithium nickel manganese cobalt oxide, lithium iron phosphate, lithium nickel cobalt aluminum oxide, lithium titanate, or any combination thereof, preferably from batteries comprising lithium nickel manganese cobalt oxide.

13. The process according to claim 1, wherein the sodium sulfate containing residue process stream from a steel production plant originates from the processing of a slag for vanadium recovery.

14. The process according to claim 13, wherein the vanadium recovery comprises vanadium purification by addition of sodium hydroxide which in turn provides vanadium pentoxide as one product stream and the sodium sulfate containing residue process stream as another product stream.

15. The process according to claim 13, wherein the sulfate containing residue process stream from a steel production plant is obtained by addition of sulfuric acid and/or aluminum sulfate after the vanadium purification.

16. The process according to claim 1, wherein the potassium chloride added to the residue process stream has been subjected to a pretreatment step including washing with water and optionally subsequent evaporation to remove any impurities present in the potassium chloride.

17. Use of a process according to claim 1 for the production of a fertilizer comprising potassium sulfate.
